(19) United States
(12) Patent Application Publication
(10) Pub. No.: US 2015/0302594 A1
(43) Pub. Date: Oct. 22, 2015

(54) System and Method For Object Detection Using Structured Light

(71) Applicants: Richard H. Moore, Concord, MA (US); Carey Rappaport, Wellesley, MA (US); Borja Gonzalez-Valdes, Boston, MA (US)

(72) Inventors: Richard H. Moore, Concord, MA (US); Carey Rappaport, Wellesley, MA (US); Borja Gonzalez-Valdes, Boston, MA (US)

(21) Appl. No.: 14/329,636

(22) Filed: Jul. 11, 2014

Related U.S. Application Data
(60) Provisional application No. 61/845,408, filed on Jul. 12, 2013.

(51) Int. Cl. G06T 7/00; H04N 13/02

(52) U.S. Cl. CPC G06T 7/0057; H04N 13/0271; G06T 7/0085; G06T 2207/10028; G06T 2207/30232

(57) ABSTRACT

A system and method for determining a volume of a body, body part, object, or stimulated or emitted field and identifying surface anomalies of the object of interest. A first set of image data is acquired corresponding to the object of interest from an imaging device. Depth data and a second set of image data is acquired from a structured light emitter including at least one sensor. A processor receives the first and second set of image data and based thereon, generates a resultant image including the depth data. A display is configured to display the resultant image to identify surface anomalies. A geometric model is applied to the resultant image to calculate a volume of the object of interest.

### CROSS-REFERENCE TO RELATED APPLICATIONS

This application is based on, claims the benefit of, and incorporates herein by reference, U.S. Provisional Patent Application Ser. No. 61/845,408, filed on Jul. 12, 2013, and entitled “STRUCTURED LIGHT ENABLED PORTAL SECURITY SYSTEMS.”

### STATEMENT REGARDING FEDERALLY SPONSORED RESEARCH

N/A

### BACKGROUND OF THE INVENTION

The present disclosure relates to systems and methods for utilizing structured light to provide information, such as depth information during imaging processes. More particularly, the disclosure relates to systems and methods for evaluating an object using depth data obtained from a structured light emitter device, including evaluating a volume of the object or a part of the object. The disclosure further relates to systems and methods for identifying surface anomalies of a subject using depth data obtained using the structured light emitter device combined with image data obtained from a two-dimensional imaging device.

Speed, complexity, and safety have been recurrent and difficult to achieve goals for imaging devices that scan, measure or otherwise collect data about three dimensional objects. With the advent of computers, such devices have useful application in many fields, such as digital imaging, computer animation, topography, reconstructive and plastic surgery, dentistry, internal medicine, rapid prototyping, and other fields. These computer-aided systems obtain information about an object and then transform the shape, contour, color, and other information to a useful, digitized form.

Several types of imaging exist and can be used across various applications ranging from medical screening to security checkpoint screening at airports, for example. Imaging of a subject can be achieved using medical imaging modalities such as Computed Tomography (CT) or Magnetic Resonance Imaging (MRI), for example; however these medical imaging modalities, among others, have several drawbacks.

For example, CT, and many other imaging modalities rely on ionizing radiation that makes repeated scans undesirable and can have negative long-term effects on the subject. For example, a single CT scan can expose a patient to the amount of radiation that epidemiologic evidence shows can be cancer causing. Additionally, although CT is useful for imaging a an object and creating three-dimensional visualization and views from various angles, the CT scanner is mechanically complex. The scanner typically requires a large, rotating frame (i.e., gantry) with an X-ray tube mounted on one side and a detector on the opposite side. A fan-shaped beam of X-rays is created as the rotating frame spins the X-ray tube and detector around the patient. As the scanner rotates, several thousand images are taken in one rotation resulting in one complete cross-sectional image of the body. As a direct result of the mechanical complexity, CT scanners require a large initial investment. In addition, CT scanners require regular maintenance, which can cost tens of thousands of dollars annually.

In contrast, MRI scanners do not rely on ionizing radiation; however MRI scanners typically require an even larger initial investment and on-going maintenance costs. MRI scanners are also mechanically complex, requiring a very powerful magnet capable of producing a large, stable magnetic field to form images of the body in combination with radio waves. While MRI systems scan with generally high accuracy, the rate at which the scanner acquires the data is relatively slow. Thus, bulk imaging or repeated scans are typically not performed, even though the patient is not exposed to ionizing radiation.

Thus, for devices that scan, measure or otherwise collect data about the geometry and material properties of an object, it would be advantageous to provide systems and methods to image across various applications ranging from medical screening to security checkpoint screening using three-dimensional information at rapid speed and avoiding safety concerns, such as are implicated by ionizing radiation and the like.

### SUMMARY OF THE INVENTION

The present disclosure overcomes the aforementioned drawbacks by providing a system and method to accurately reconstruct a three-dimensional volume image of a body, body part, object, or stimulated or emitted field without the use of ionizing radiation, without requiring cumbersome or slow imaging systems, and without prohibitive system or maintenance costs. In particular a three-dimensional imaging system is provided that projects known patterns of light onto an object and can determine depth information in a highly-efficient and cost-effective manner based thereon.

In accordance with one aspect of the disclosure, a system for determining a volume of an object of interest is disclosed. The system includes a structured light emitter configured to project a predetermined pattern of light onto the object of interest. The system further includes at least one sensor configured to acquire light after impinging the object of interest in the predetermined pattern to generate volumetric position data based thereon. The system further includes a processor configured to receive the volumetric position data and based thereon, generate a depth map of the object of interest. The processor may further be configured to apply a geometric model to the depth map to calculate the volume of the object of interest. A display is configured to indicate the volume of the object of interest based on a reconstructed volumetric shape determined by the geometric model.

In accordance with another aspect of the disclosure, a method for determining a volume of an object of interest of interest is disclosed. The method includes projecting a predetermined pattern of light onto the object of interest from a structured light emitter. The method further includes acquiring depth data corresponding to the object of interest provided at a predetermined location from a structured light emitter in the predetermined pattern of light. The method further includes generating a depth map of the object of interest from the depth data and applying an edge detection algorithm to the depth map to isolate the object of interest. The depth map may be reconstructed using a geometric model representative of a volumetric shape of the isolated object of interest. The volume of the object of interest is then calculated based on the reconstructed volumetric shape.

In accordance with one aspect of the disclosure, a system for identifying surface anomalies of an object of interest is disclosed. The system includes an imaging device configured to acquire a first set of image data corresponding to the object of interest. The system further includes a structured light emitter configured to project a predetermined pattern of light onto the object of interest. At least one sensor is configured to acquire light after impinging the object of interest in the predetermined pattern to generate depth data and a second set of image data based thereon. A processor is configured to receive the first set of image data, the second set of image data, and the depth data and based thereon, generate a depth map of the object of interest. Common points are identified between the first set of image data and the second set of image data. A display is configured to indicate surface anomalies of the object of interest based on a resultant image created from correlating the common points between the first set of image data and the second set of image data. The resultant image includes the depth data.

In accordance with another aspect of the disclosure, a method for identifying surface anomalies of an object of interest is disclosed. The method includes projecting a predetermined pattern of light onto the object of interest from a structured light emitter. The method further includes receiving a first set of image data from an imaging device corresponding to an object of interest. The method further includes acquiring depth data and a second set of image data, simultaneously, corresponding to the object of interest provided at a predetermined location from the structured light emitter in the predetermined pattern of light. A depth map of the object of interest is generated from the depth data. Next an edge detection algorithm is applied to the first set of image data and the second set of image data to identity a boundary of the object of interest. Common points between the first set of image data and the second set of image data are identified, and the first set of image data is combined with the second set of image data based on the common points to obtain a resultant image including the depth data of the object of interest. Then, surface anomalies of the object of interest are identified from the resultant image.

In accordance with one aspect of the disclosure, a system including an imaging device configured to acquire a first set of image data corresponding to an object of interest is disclosed. The system further includes a structured light emitter configured to project a predetermined pattern of light onto the object of interest. At least one sensor is configured to acquire light after impinging the object of interest in the predetermined pattern to generate depth data and a second set of image data based thereon. A processor is configured to receive at least one of the first set of image data, the second set of image data, and the depth data and based thereon, generate a resultant image including the depth data. A display is configured to display the resultant image.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a block diagram of a system configured to implement the present disclosure.

FIG. 2 is a flow chart setting forth the steps of processes for determining a volume of an object of interest in accordance with the present disclosure.

FIG. 3A is a perspective view of on an object of interest of which a volume is to be determined.

FIG. 3B is a perspective view of the object of interest of FIG. 3A positioned a predetermined distance from a structured light emitter

the object of interest may be an arm 302 of a subject, provided at the predetermined distance D from the structured light emitter 304. The predetermined distance D may be determined by minimizing the error in actual distance and perceived distance by the structured light emitter of a point on the arm 302.

FIG. 4A is an example depth image of the object of interest positioned within a working range of a structured light emitter.

FIG. 4B is a graph showing a percent error of depth point over 100 images of the object of interest within the structured light emitter's working range.

FIG. 5A is an example depth image of the object of interest positioned within a different working range of the structured light emitter.

FIG. 5B is a graph showing a percent error of depth point over 100 images of the object of interest within the structured light emitter's working range.

FIG. 6A is a graph showing various distances of the structured light emitter from the object of interest and the corresponding percent errors.

FIG. 6B is a graph showing various distances of the structured light emitter from the object of interest and the corresponding precision values.

FIG. 7A is a side perspective view of a cylindrical geometric model used to calculate the volume of the object of interest.

FIG. 7B is a side perspective view of a cylindrical geometric model with varying radii used to calculate the volume of the object of interest.

FIG. 7C is a side perspective view of a rectangular geometric model with a series of rectangular slices used to calculate the volume of the object of interest.

FIG. 8 is a block diagram of a system configured to implement another aspect of the present disclosure.

FIG. 9 is a flow chart setting forth the steps of processes for identifying surface anomalies of an object of interest in accordance with the present disclosure.

FIG. 10 is a three-dimensional depth surface image created from image data and depth data acquired from an imaging device and a structured light emitter.

FIG. 11A is an image boundary and common points of an object of interest created from the image data acquired from the structured light emitter.

FIG. 11B is an image boundary and common points of the object of interest created from the image data acquired from the imaging device.

FIG. 12 shows a graph relating triangles corresponding to the common points of FIGS. 11A and 11B.

FIG. 13 is an illustration of a cylindrical-coordinate representation of points in an RGB color model.

FIG. 14A is a resultant image created using one way color to define hue by the imaging device and value by the depth data obtained from the structured light emitter.

FIG. 14B is a resultant image created using one way color to define hue by the depth data obtained from the structured light emitter and value by the imaging device.

FIG. 15 is a three-dimensional representation of the object of interest with projected X-ray background material responses.

FIG. 16A is a perspective view of an exemplary subject having an object attached thereto for imaging.

FIG. 16B is a resultant image of the subject of FIG. 16A highlighting the object attached to the subject.

### DETAILED DESCRIPTION OF THE INVENTION

As will be described, the present disclosure provides systems and methods for utilizing structured light to generate a three-dimensional volume image of an object, as well as identify surface anomalies of an object in conjunction with a two-dimensional imaging device. The present three-dimensional imaging system incorporates the use of structured light, which projects a known pattern(s) of light, often grids or horizontal bars, but also random dot patterns as optimal onto an object. Depth may be calculated based on a triangulation process of determining a location of a point by measuring angles to it from known points along a triangulation baseline, without measuring the depth directly. The structured light three-dimensional surface imaging can extract the three-dimensional surface shape based on the information from the distortion of the projected structured light pattern. Accurate three-dimensional surface profiles of a body, body part, object, or stimulated or emitted field in the scene (as used herein, “object of interest”) can be computed by using various structured-light principles and algorithms, as will be described in further detail below.

Technologies for active depth sensing have improved depth estimation approaches though the use of structured light to extract geometry from a scene. With existing technology, a structured infrared (IR) pattern can be projected onto the scene and photographed by a single IR camera. Based on deformations of the light pattern, geometric information about the underlying scene can be determined and used to generate a depth map. However, despite the advantages of structured light technology, the use of structured light and corresponding depth data has only been used in a limited number of applications.

One application where depth data may be advantageous is in lymphedema screening, for example. Lymphedema occurs when lymphatic vessels become blocked resulting in the collection of lymph fluid and consequentially the swelling of the limb where the lymph vessels are blocked. In the case of breast cancer, axillary lymph nodes can be removed during surgery which results in the development of lymphedema in the patient's arm respective to which breast the cancer was removed from. Currently, the severity of a patient's lymphedema is determined by attempting to assess the amount of extra fluid in the affected arm.

Conventional screening programs for assessing the potential occurrence or progression of lymphedema in breast cancer patients post-surgery or during radiation therapy, require physicians to monitor the change in the patient's affected limb compared to the unaffected limb by measuring the girth of each arm using a measuring tape. This method, however, is an inconsistent method of screening that is highly subject to human error. Alternatively, other screening programs for lymphedema use infrared imaging devices or bio-impedance devices that scan across the arm and reconstruct a three-dimensional volume of the arm. While the infrared imaging devices and bio-impedance devices can estimate the volume of the arm with approximately 3-5% accuracy, these devices are very costly, bulky, and difficult to repair and replace.

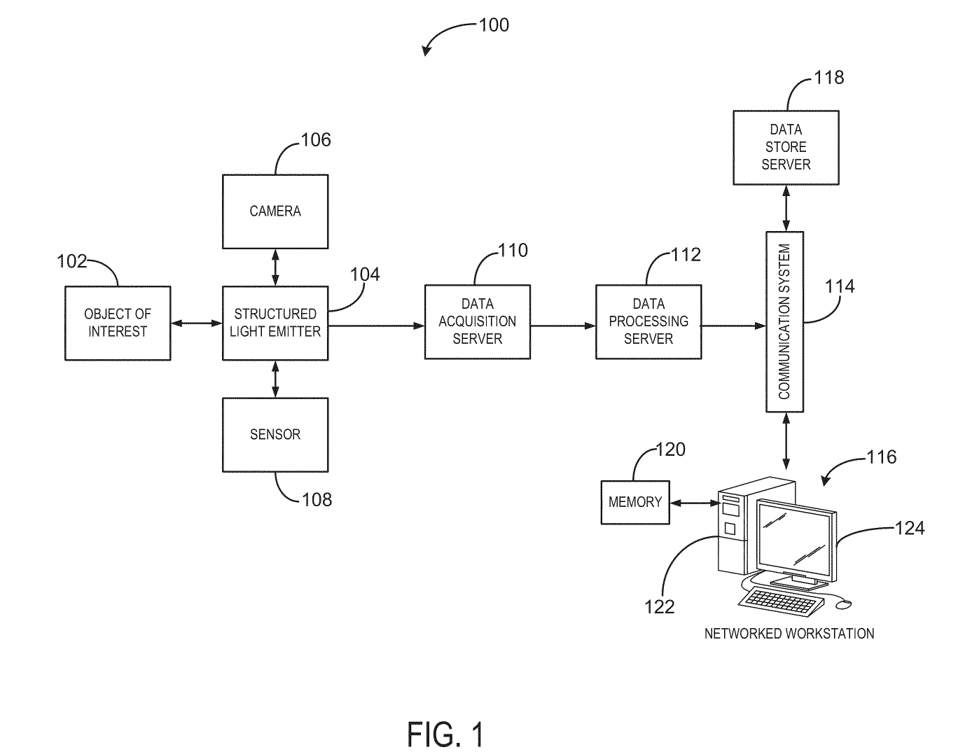

Referring particularly now to FIG. 1, a system 100 is shown that is configured to acquire a data from an object of interest 102. The data may be, for example, volumetric position data acquired by a structured light emitter 104, a camera 106 and a depth sensor 108, such as illustrated in FIG. 1. The volumetric position data is sent to a data acquisition server 110 coupled to the system 100. The data acquisition server 110 then converts the volumetric position data to a dataset suitable for processing by a data processing server 112, for example, to reconstruct one or more images from the dataset. The dataset or processed data or images can then be sent over a communications system 114 to a networked workstation 116 for processing or analysis and/or to a data store server 118 for long-term storage. The communication system 114, which may be local or wide, a wired or wireless, network including, for example, the internet, allows the networked workstation 116 to access the data store server 118, the data processing server 112, or other sources of information.

The camera 106 may be capable of taking static pictures or video. In one configuration, the camera, when taking a picture, captures color data (e.g., red, green, blue) and depth data, or volumetric position data, is acquired through the depth sensor 108. The depth data indicates the proximity-in one configuration, on a per-pixel basis-of objects being captured by the camera 106 to the camera itself. The depth data, or volumetric position data, may be captured in a number of ways, like using an infrared (IR) camera to read projected IR light, reading projected laser light, or the like from the structured light emitter 104. The depth data may be stored in a per-centimeter, per-meter, or other spatial representation. For example, IR dots may be projected and read by an IR camera, producing an output file that details the depth of the object of interest 102 in an area directly in front of the camera 108, measured in a per-meter orientation. Additionally, depth data may also indicate the orientation of a particular part of the object of interest 102 by recording the pixels of screen area where depth is measured. Because the camera 106 and the depth sensor 108 may be located separately from one another, conversions may be made to map retrieved color data to corresponding depth data. The structured light emitter 104, the camera 106 and the sensor 108 may be communicatively coupled as a single device, such as the Microsoft Kinect™ created by the Microsoft Corporation®, thereby requiring little maintenance.

The networked workstation 116 includes a memory 120 that can store information, such as the dataset. The networked workstation 116 also includes a processor 122 configured to access the memory 120 to receive the dataset or other information. By way of example, and not limitation, the memory 120 may be computer-storage media that includes Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the processor 122.

The network workstation 116 also includes a user communication device, such as a display 124, that is coupled to the processor 122 to communicate reports, images, or other information to a user.

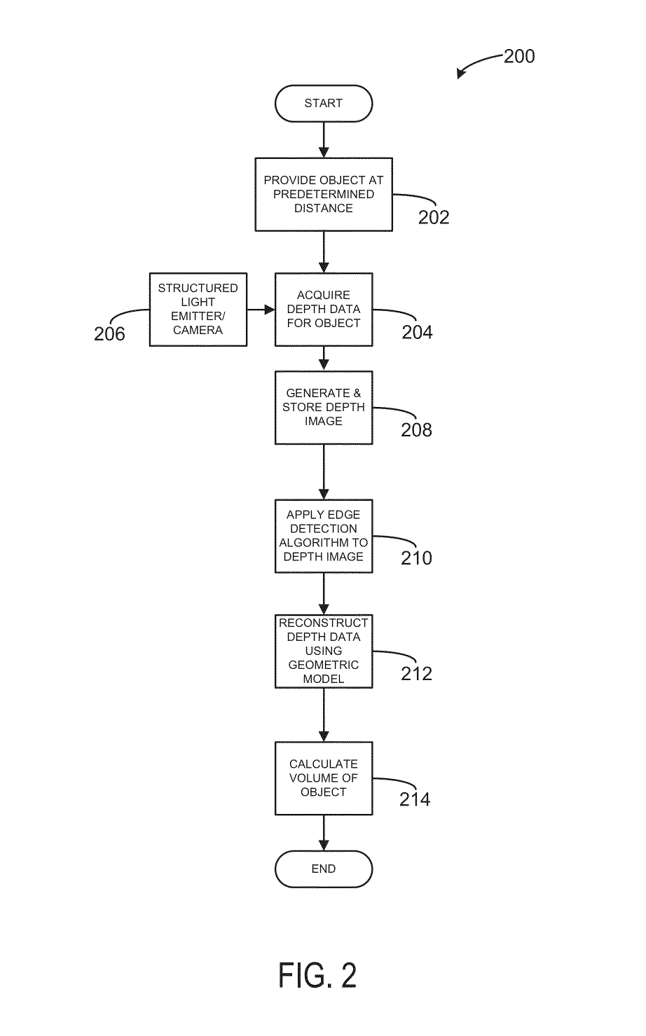

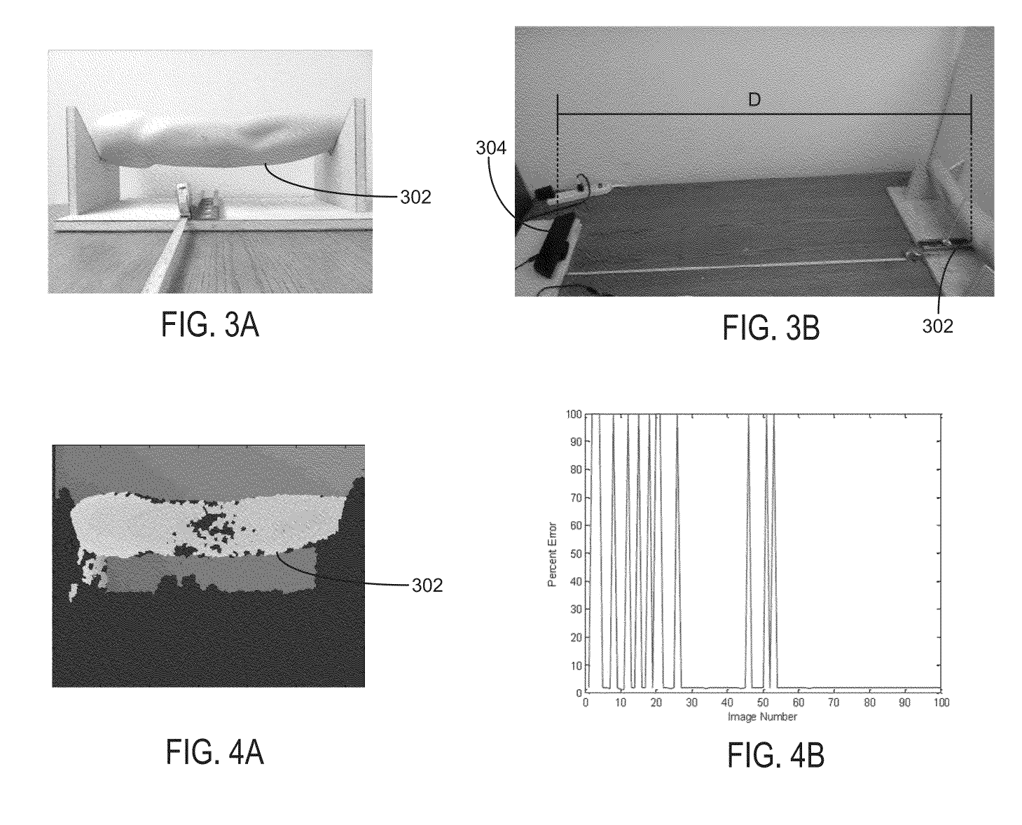

Referring now to FIG. 2, a flow chart setting forth exemplary steps 200 for determining a volume of an object of interest is provided. To start the process, the object of interest 102 is provided at a predetermined distance from the structured light emitter 104, as shown in FIG. 1, at process block 202. In one non-limiting example, as shown in FIGS. 3A and 3B, the object of interest may be an arm 302 of a subject, provided at the predetermined distance D from the structured light emitter 304. The predetermined distance D may be determined by minimizing the error in actual distance and perceived distance by the structured light emitter of a point on the arm 302. To do this, RGB and corresponding depth images of the arm 302 are acquired by the structured light emitter 304. The percent error in distance for each of the hundred images was then calculated using equation (1) below:

$$\% error = \frac{\vert x - y \vert}{x} \qquad ( 1 )$$

Where x is the actual distance of the point from the structured light emitter 304 and y is the observed distance. The average of these errors may be used to determine the overall percent error. In addition, the consistency of the observed distance, namely the precision, may be determined using equation (2) below:

Precision=( x̅−min(x))+(max(x)− x̅) (2)

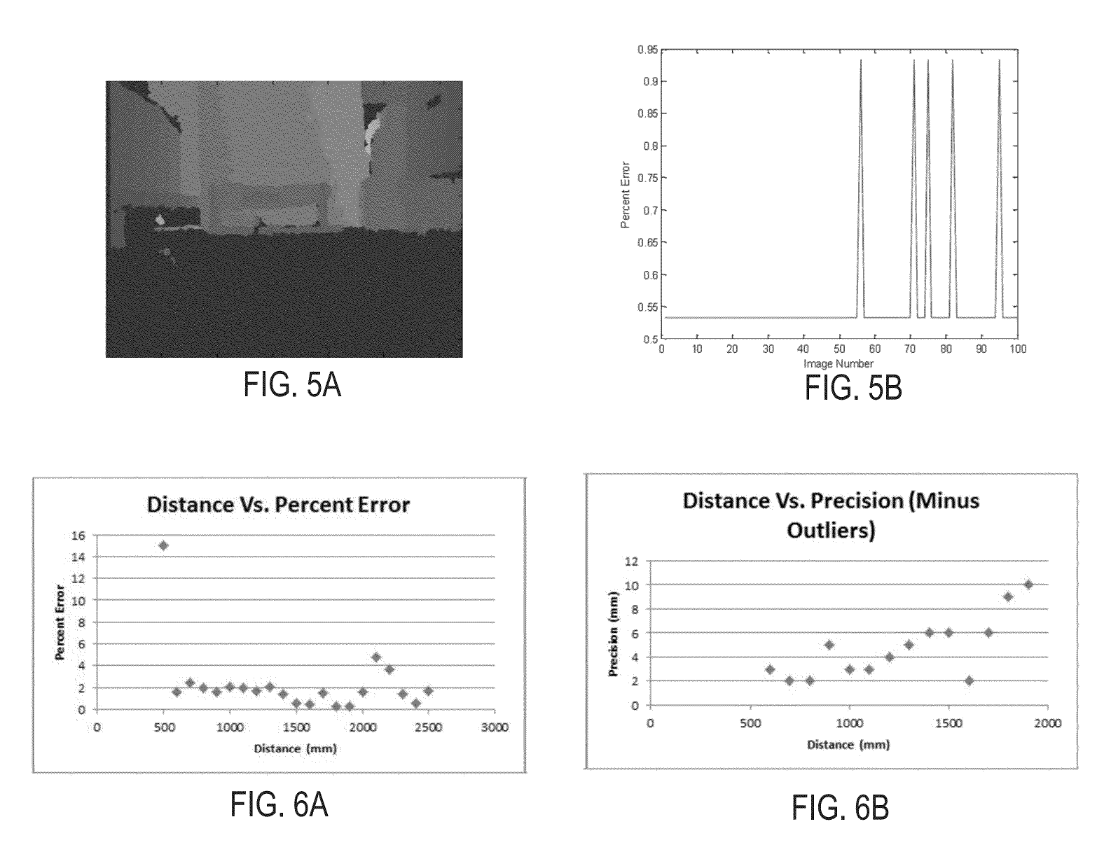

In some configurations, the accuracy and precision of the observed distance may be determined in 10 centimeter increments within the structured light emitter's 304 working range (e.g., from about 50 centimeters to about 250 centimeters) to find the ideal range, or the predetermined distance D, for screening. For example, the results at 50 centimeters are shown in FIGS. 4A and 4B, where the overall percent error was 14.98% and the precision was 493 millimeters. However, a significantly smaller error was obtained within the structured light emitter's 304 working range at an observed distance of 150 centimeters, as shown in FIGS. 5A and 5B. An overall error of 0.55% and precision of 6 millimeters was observed at 150 centimeters. Other implementations, optimized for lower frame rates and higher depth accuracy and precision permit a tradeoff to achieve the optimal combination for any particular desired measurement of a body, body part, object, or stimulated or emitted field (i.e., “object of interest”).

Thus, as the distance of the structured light emitter 304 approaches 200 centimeters, the overall error and the precision begin to increase. This is due to the distance of the object of interest 302 from the structured light emitter 304, as the arm becomes further away from the structured light emitter 304, the physical space each pixel represents increases. Therefore, minor fluctuations in measurement or lighting can have a more drastic effect on how the pixel's depth is mapped out. The distribution of error and precision in comparison to the distance of the structured light emitter 304 from the arm 302 is shown in FIGS. 6A and 6B. Thus, the predetermined distance D for screening between about 70 centimeters to about 120 centimeters for a particular implementation.

Returning to FIG. 2, once the object of interest is provided at the predetermined distance from the structured light emitter at process block 202, the structured light emitter 206 can project a predetermined pattern of structured light onto the object of interest and the camera can detect the presence of projected features on the object of interest. The predetermined pattern of structured light may include, but is not limited to, a patterned grid, a checkerboard pattern, a dot or line pattern, and the like The pattern of illuminated dots are those that sample the target object vertically and horizontally with sufficient resolution to capture the object's surface variation to the desired fidelity.

At process block 204, the depth data of the object of interest can be acquired using the depth sensor which acquires light after impinging the object of interest in the predetermined pattern of light. The depth data may be acquired from the structured light emitter and camera device, as shown at block 206. As previously described, the structured light emitter 104, the camera 106 and the sensor 108 shown in FIG. 1 may be communicatively coupled as a single device, such as the Microsoft Kinect™ created by the Microsoft Corporation®. The device 206 can generate both an RGB image and depth image stream. If pixels obtained from the device cannot be read properly by the data processing server 112, the processor 122 may be configured to set that particular pixel value to zero. Advantageously, since the device 206 uses structured light, the object of interest is not exposed to ionizing radiation, thereby allowing the object of interest to be quickly and repeatedly scanned, if necessary, without damaging or costly implications.

Once the depth data is acquired for the object of interest at process block 204, a depth image, such as the image shown in FIG. 4A or FIG. 5A, for example, may be generated and stored at process block 208. The depth images are generated at process block 208 by acquiring two dimensional images with a corresponding depth value for each two dimensional coordinate using an infrared grid (not shown). A matrix of the acquired depth values may be created and stored in a text file, for example, for each pixel of the image. The resultant three dimensional depth image can then be used to estimate the volume of the object of interest positioned in a field of view of the device 206, as will be described in further detail below.

In some configurations, a depth map and a pointer to an image color map are acquired for each image and written to a blank image the size of the device 206 resolution of 640×480 pixels, for example. Each color obtained from the pointer to the color map can be separately written to a different blank image to create an RGB image. Thus, pixels having corresponding depth values within a predefined range may be represented by a first color, while pixels having corresponding depth values with a different predefined range may be represented by a different color. As a result, closer objects may appear brighter and further objects from the structured light emitter may appear darker, for example, within the depth image.

Once the depth image is generated and stored at process block 208, the processor 122 of FIG. 1 may be configured to apply an edge detection algorithm to the depth image at process block 210 in order to isolate the object of interest 102 (e.g., the arm) from any structures that are part of the object of interest 102. The depth data may be used to locate the edges of the object of interest 102 in the depth image. Identifying the edges may commence outwardly from the closest point, looking for drastic differences in the depths of points. For example, the edge of the arm 302 in FIG. 3A may have a point that is nearly half a meter closer than an adjacent point representing wall behind the arm 302. Such a drastic difference represents a readable signal that the adjacent point is not part of the arm 302 (i.e., the object of interest) and thus should not be included in further reconstruction steps, as will be described in further detail.

In one non-limiting example, the edge detection algorithm applied to the depth image is a Sobel edge detector. The operators of the Sobel edge detector are masks of n×n windows, one for x-components and one for y-components, as shown below in equations (3), which are convolved with the incoming image to assign each pixel a value. To obtain better results, the method applies between two and four masks to find edges in the image. This Sobel edge detector algorithm uses four operators (i.e., masks or kernels) of 3×3 windows which measure the intensity variation of the image when they are convolved with it in four directions: horizontal, vertical, right diagonal, and left diagonal. In other words, the Sobel edge detector convolves the kernels shown below with an image, which takes the derivative of the image in the x and y direction. The Sobel image only has active pixels based on changes in intensities in the original image.

$${S}_{x} = [ \begin{matrix}- 1 & 0 & + 1 \\ - 2 & 0 & + 2 \\ - 1 & 0 & + 1\end{matrix} ] {S}_{y} = [ \begin{matrix}+ 1 & + 2 & + 1 \\ 0 & 0 & 0 \\ - 1 & - 2 & - 1\end{matrix} ] \qquad ( 3 )$$

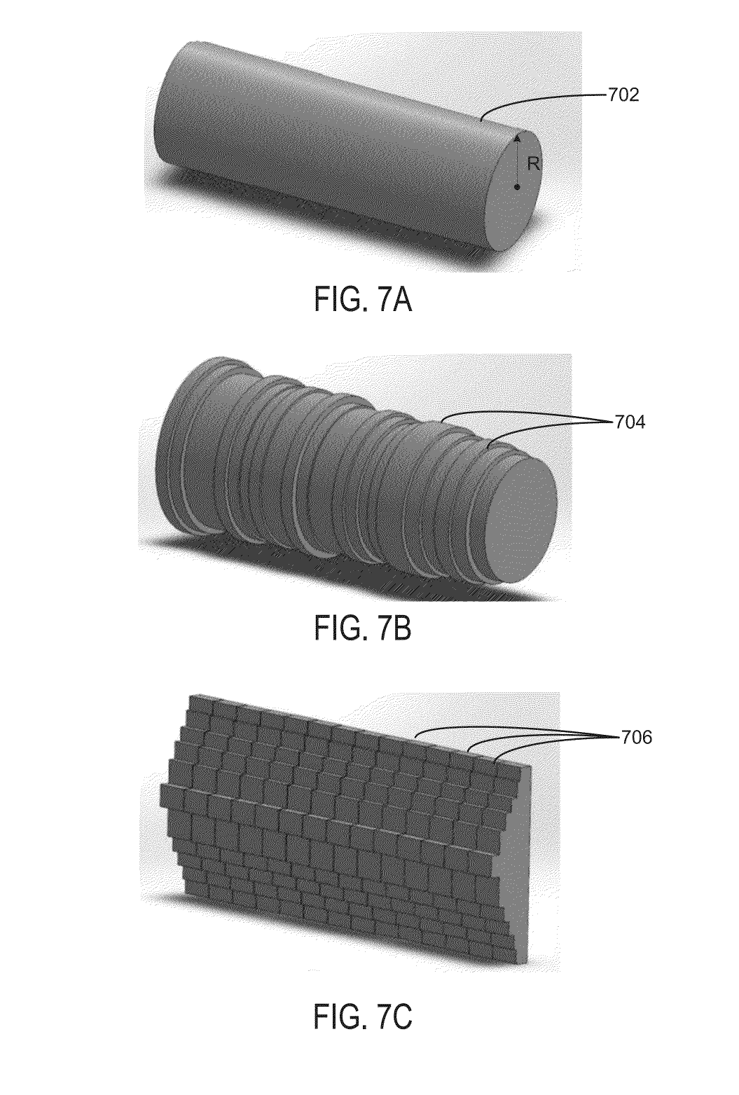

Once the object of interest 102 is isolated using the edge detection algorithm at process block 210, the depth data can be reconstructed using a geometric model at process block 212 in order to calculate a volume of the object of interest 102. The geometric model can use the depth data acquired within the screening working range of the structured light emitter 104 and model the depth data to estimate the volume of the object of interest, such as the arm 302 shown in FIG. 3A. In one non-limiting example, the arm 302 can be modeled as a cylinder 702 as shown in FIG. 7A, a series of cylinders 704 with varying radii as shown in FIG. 7B, or as a series of rectangular slices 706 as shown below in FIG. 7C. The cylindrical and circular geometric models, as shown in FIGS. 7A and 7B, can model the volume of the arm 302 because of geometric similarities. However, the rectangular geometric model, as shown in FIG. 7C divides the arm 302 into the series of thin, rectangular slices 706 to model the irregular arm shapes that can occur due to Lymphedema, which causes a condition of localized fluid retention in the arm and/or leg. Additionally the rectangular geometric model can be used to model a Lymphedema stricken hand which the cylindrical and circular geometric models may not accurately represent.

Next, at process block 214, the volume of the object of interest can be calculated from the reconstructed depth data at process block 212. For the cylindrical geometric model, as shown in FIG. 7A, the radius R of the cylinder 702 can be determined by finding the point with the greatest depth in the center column of the edge detected image and subtracting the point with the least depth in the same column. Since the radius R of the entire cylinder 702 depends on how the object of interest, such as the arm 302, is centered in the image, the estimated volume using the cylindrical geometric model becomes much greater or less than the actual volume of the arm 302, since the fixed cylindrical estimates truncate or overcompensate for changes in the girth of the arm 302.

The dynamic cylindrical geometric model, as shown in FIG. 7B, may be more consistent than the fixed cylindrical model shown in FIG. 7A. However, the estimated volume using the dynamic cylindrical geometric model may estimate a volume of the arm 302 that is over the actual volume of the arm. This is because the flat side of the arm 302 may face away from the structured light emitter 104, which can result in the algorithm assuming that the arm 302 has an overall bigger radius, and thus resulting in an over-calculated volume.

Lastly, the rectangular geometric model, as shown in FIG. 7C, of the arm 302 may be the closest to the actual volume of the arm. However, these volumes doubled the volume estimated of the front of the arm 302 to obtain the overall volume and did not account for an asymmetric back of the arm 302. In one non-limiting example, to obtain the volume of the back of the arm 302, the reflection of the infrared beams emitted from the structured light emitter off multiple mirrors behind the arm 302 can be analyzed to break up the back of the arm into separate volumes that can be added to the front to estimate an overall, asymmetrical volume of the arm 302.

Once the volume of the object of interest, for example the arm 302, is calculated at process block 214, the severity of a patient's lymphedema can be determined since the estimated volume can indicate the amount of extra fluid in the affected arm. Advantageously, the system 100 can calculate the volume of the object of interest (e.g., the arm or leg) for subjects of various sizes. For example, the system 100 may calculate the volume of an arm of an adult, as well as the volume of an arm of a child, which may be significantly smaller. Thus, the system 100 is capable of estimating a wide variance of volumes.

Another application that may benefit from depth data, or volumetric position data, acquired from structured light technology is security checkpoint screening systems at airports, for example. Checkpoint screening is used to detect non-permitted items from being carried from the public side of commercial airports to the “secure” (sometimes called “sterile”) area. The “secure side” is physically isolated from the public area. All persons on the “secure side” are presumed to be free of contraband and non-permitted materials such as explosives and weapons.

Two conventional technologies are employed to screen passengers, one-at-a-time, except for carried infants, which include millimeter-wave near field imaging and X-ray backscatter (XBS). While these conventional imaging technologies provide information about the materials on a person, neither measures depth. Rather, a two-dimensional static or two-dimensional video of the response is measured. The human observer then combines the distance cues present in the two-dimensional image to mentally create a sense of distance. However, their ability to characterize body-borne security threats is limited. Thus, a structured light subsystem, such as a structured light emitter, as previously described, may be used in conjunction with millimeter-wave near field imaging and/or XBS to generate a digital surface representation of objects including accurate depth measurement.

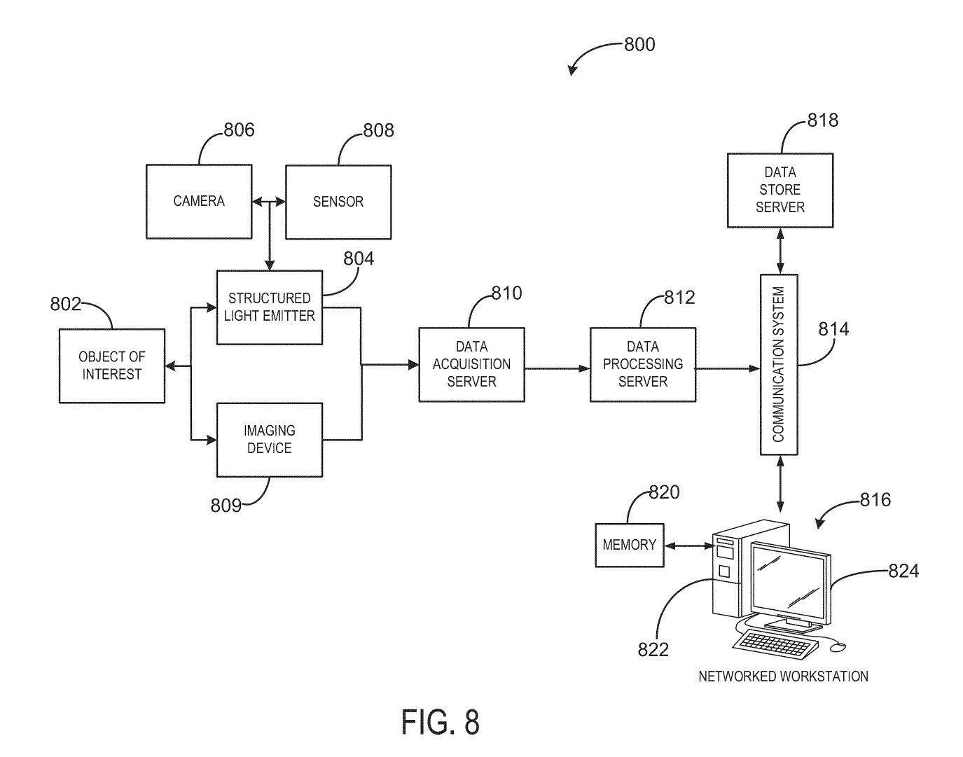

Referring particularly now to FIG. 8, a system 800 is shown that is configured to acquire a data from an object of interest 802. The data may be, for example, depth data acquired by a structured light emitter 804, a camera 806 and a depth sensor 808, such as illustrated in FIG. 8. The system 800 also includes an imaging device 809 that also acquired imaging data of the object of interest. The imaging device may be a millimeter-wave near field imaging device or a XBS imaging device. Also, the imaging device may include single and multiple energy CT, 2-D X-ray, limited angle CT, infrared imaging, ultrasound imaging, mm wave, radar, low-angle coherent scatter systems, acoustic (sound localization) imaging, impedance imaging, quadrapole-resonance imaging, terrahertz imaging, other optical camera systems, and the like. The depth data and imaging data is sent to a data acquisition server 810 coupled to the system 800. The data acquisition server 810 then converts the depth data and imaging data to a dataset suitable for processing by a data processing server 812, for example, to reconstruct one or more images from the dataset. The dataset or processed data or images can then be sent over a communications system 814 to a networked workstation 816 for processing or analysis and/or to a data store server 818 for long-term storage. The communication system 814, which may be local or wide, a wired or wireless, network including, for example, the internet, allows the networked workstation 816 to access the data store server 818, the data processing server 812, or other sources of information.

The camera 806 may be capable of taking static pictures or video. In one configuration, the camera, when taking a picture, captures depth data acquired through the depth sensor 808. The depth data indicates the proximity-in one configuration, on a per-pixel basis-of objects being captured by the camera 806 to the camera itself. The depth data, may be captured in a number of ways, like using an infrared (IR) camera to read projected IR light, reading projected laser light, or the like from the structured light emitter 804. The depth data may be stored in a per-centimeter, per-meter, or other spatial representation. For example, IR dots may be projected and read by an IR camera, producing an output file that details the depth of the object of interest 802 in an area directly in front of the camera 808, measured in a per-meter orientation. Additionally, depth data may also indicate the orientation of a particular part of the object of interest 802 by recording the pixels of screen area where depth is measured. The structured light emitter 804, the camera 806 and the sensor 808 may be communicatively coupled as a single device, such as the Microsoft Kinect™ created by the Microsoft Corporation®.

The networked workstation 816 includes a memory 820 that can store information, such as the dataset. The networked workstation 816 also includes a processor 822 configured to access the memory 820 to receive the dataset or other information. By way of example, and not limitation, the memory 820 may be computer-storage media that includes Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the processor 822.

The network workstation 816 also includes a user communication device, such as a display 824, that is coupled to the processor 822 to communicate reports, images, or other information to a user. For example, the display may show body scans that provide information about both the shapes of materials imaged and their approximate depth. The structured light emitter 804 can provide overall depth information in a specific region of the object of interest 802. The combined images from the structured light emitter 804 and the imaging device 804 help to quickly distinguish threats by identifying surface anomalies or object bulges beyond the expected skin surface of the object of interest 802. The images may be processed, registered, and combined to create an image where the XRB scattering intensity is encoded by color and the depth is encoded by the brightness of the image. Thus, the resulting image makes bulges stand out from the object of interest 802 and draw focus to any potential threat.

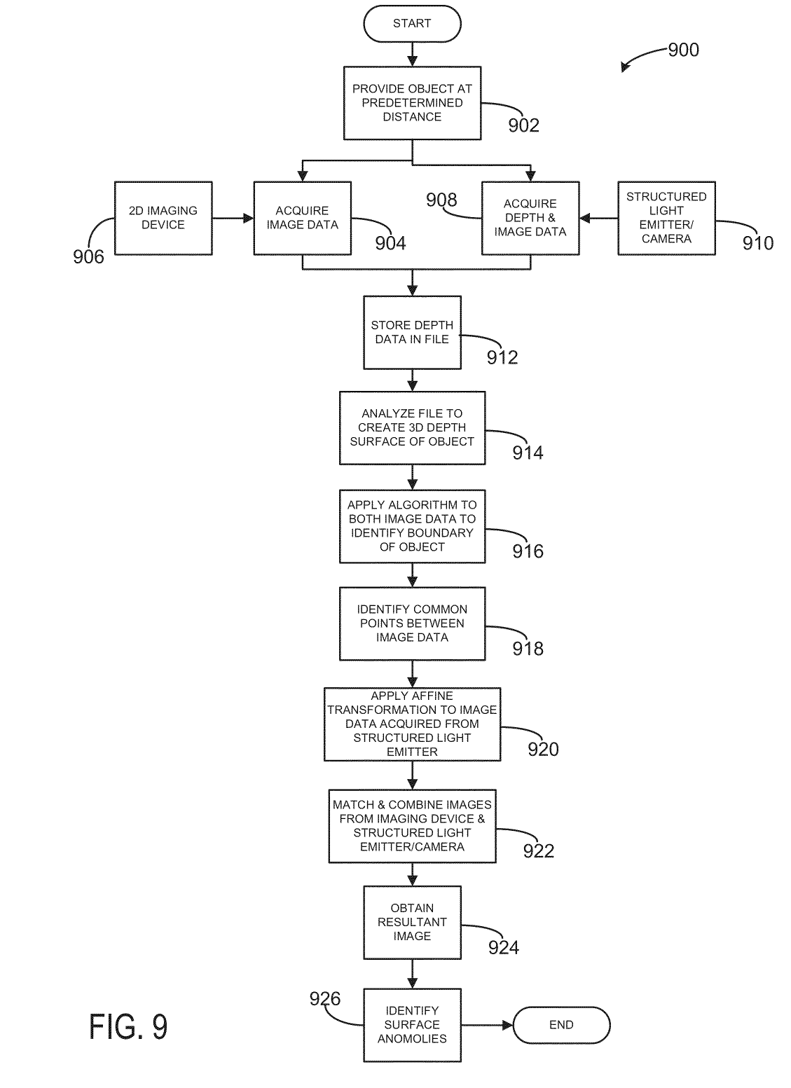

Referring now to FIG. 9, a flow chart setting forth exemplary steps 900 for identifying surface anomalies of an object of interest is provided. To start the process, the object of interest 802 is provided at a predetermined distance from the structured light emitter 804, as shown in FIG. 8, at process block 902. In one non-limiting example, the object of interest may be a subject, provided at the predetermined distance from the structured light emitter 804 and the imaging device 809. The predetermined distance may be established in a similar manner as described with respect to the system 100 of FIG. 1.

Once the object of interest is provided at the predetermined distance, which may be an optimal distance, or sequentially at successive predetermined distances for sets of such images from the imaging device 809 and structured light emitter 804 at process block 902, a first set of image data can be acquired at process block 904. The first set of image data may be acquired from the imaging device, as shown at block 906. As previously described, the imaging device may be a backscatter X-ray (XBS) device that captures images created when objects or materials, such as the object of interest, scatter X-ray photons. Items that are low on the periodic table (e.g., hydrogen, carbon, and lithium) have a more powerful scattering effect on photons, whereas higher-level periodic table elements (e.g., metals and the like) absorb more photons and thus, have less scatter effects. Also, the imaging device may include single and multiple energy CT, 2-D X-ray, limited angle CT, infrared imaging, ultrasound imaging, mm wave, radar, low-angle coherent scatter systems, acoustic (sound localization) imaging, impedance imaging, quadrapole-resonance imaging, terrahertz imaging, other optical camera systems, and the like. The data acquisition server 810 and data processing server 812 of FIG. 8 can then measure, correlate and produce an image of the object scanned.

As the first set of image data is being acquired at process block 904, depth data and a second set of image data may be acquired simultaneously at process block 908. The depth data and the second set of image data may be acquired from the structured light emitter, camera device and sensor, as shown at block 910. As previously described, the structured light emitter 804, the camera 806 and the sensor 808 shown in FIG. 8 may be communicatively coupled as a single device, such as the Microsoft Kinect™ created by the Microsoft Corporation®. The device 906 can generate both an RGB image and depth image stream.

Once the depth data and the second set of image data is acquired for the object of interest at process block 908, a depth image may be generated and stored at process block 912. The depth images are generated at process block 912 by acquiring two dimensional images with a corresponding depth value for each two dimensional coordinate using an infrared grid (not shown). A matrix of the acquired depth values may be created and stored in a text file, for example, for each pixel of the image.

In some configurations, a depth map and a pointer to an image color map are acquired for each image and written to a blank image the size of the device 906 resolution of 640×480 pixels, for example. Each color obtained from the pointer to the color map can be separately written to a different blank image to create an RGB image. Thus, pixels having corresponding depth values within a predefined range may be represented by a first color, while pixels having corresponding depth values with a different predefined range may be represented by a different color. As a result, closer objects may appear brighter and further objects from the structured light emitter may appear darker, for example, within the depth image.

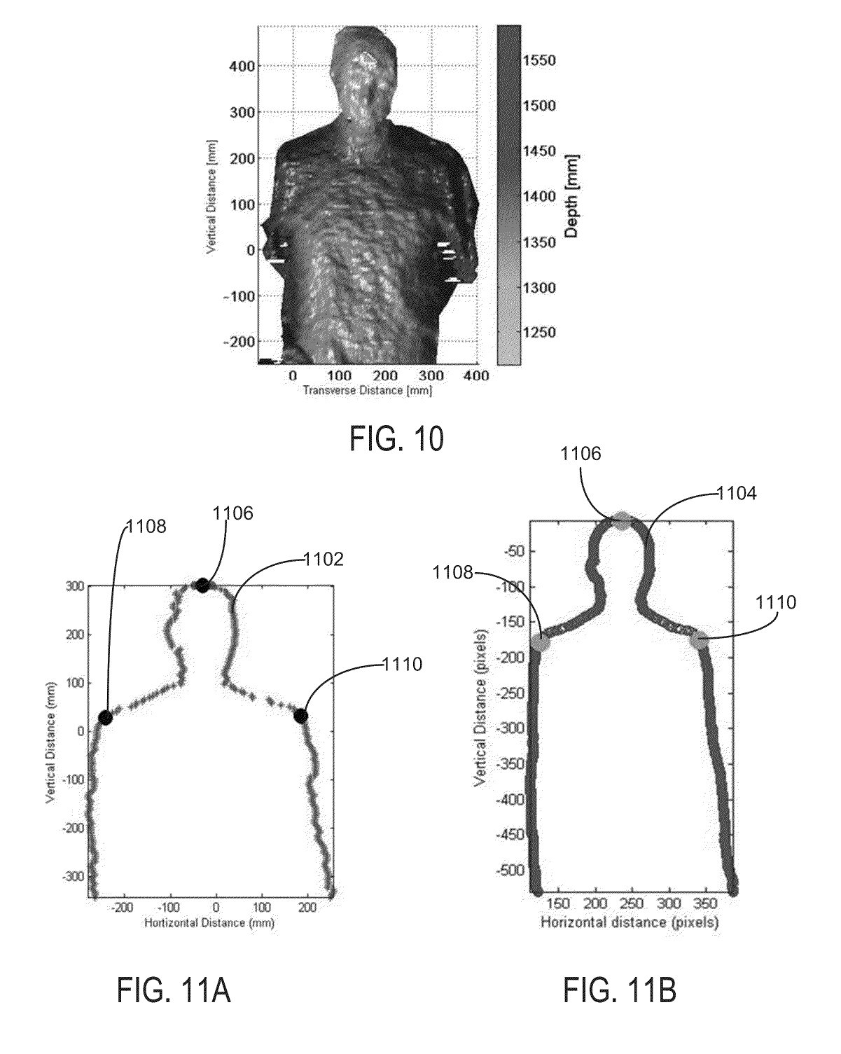

In order to collect the image data from the imaging device 906 and the structured light emitter device 910 simultaneously, the structured light emitter device 910 can be mounted on top of the imaging device 906, such as an XBS scanner. Thus, as the imaging device 906 scans the object of interest (i.e., the subject), the structured light emitter device 910 simultaneously takes depth data, storing it in text files which list the points in the depth images and the depth of those points. The text files may be combined and the image data may be layered together to create a single text file that has the data from the full scan. The text file is then analyzed to create a three-dimensional depth surface image, as seen in FIG. 10, at process block 914.

Next, an algorithm may be applied to the first and second sets of image data to register the image data sets. For example, at process block 916, an algorithm may be applied to the first and second sets of image data acquired at process block 904 and 908, respectively to identify a boundary of the object of interest. First the algorithm may find the outline of the body in both sets of image data and may create a matrix of these points. For example, an image boundary 1102 created from the image data acquired from the structured light emitter 910 is shown in FIG. 11A. Similarly, another image boundary 1104 is shown in FIG. 11B created from the image data acquired from the imaging device 906.

To determine the matrix that defines transformation between the first set of image data and the second set of image data (i.e., the image data acquired from the imaging device and the structured light emitter), three points 1106, 1108, and 1110 are found that are common between the two images, as shown in FIGS. 11A and 11B. The elements of the matrix relating points on the two images are determined by solving using a system of equations. In one non-limiting example, the top of the subject's head and shoulders are chosen to be the basis points as they are points that software can readily select automatically. In addition, these points 1106, 1108, and 1110 are not obscured or changed by clothing, for example, which appears in second set of image data acquired from the structured emitter, but does not appear in the first set of image data acquired from the imaging device.

The point 1106 on the top of the subject's head is found by finding the median point in the top row of the outline 1104. The shoulder points 1108, 1110 for each side may be found by first finding the outline points which have the greatest curvature. Since each edge has only one point per row, a greater difference in x-value (i.e., row index) corresponds to a lower slope. The points 1108, 1110 may be defined as the beginning of the shoulders and a separate matrix with the points 1108, 1110 that make up the shoulders is created. The data may then be smoothed by taking a five point moving average and interpolating the data, for example. A second difference may be found for the shoulder matrix and the point with the maximum second difference is defined as a shoulder point 1108, 1110.

Once the common points 1106, 1108, 1110 are identified at process block 918, an affine transformation may be applied to the second set of image data acquired from the structured light emitter at process block 920. Because the image data obtained from the imaging device and the structured light emitter are both analyzed using the shoulder points 1108, 1110 and the top of the head points 1106, a basis is provided for the affine transform. An affine transformation is a function that scales, sheers, rotates, and translates sets of points while maintaining parallel lines. By applying an affine transformation to the second set of image data acquired from the structured light emitter, the second set of image data is able to be combined with the first set of image data acquired from the imaging device.

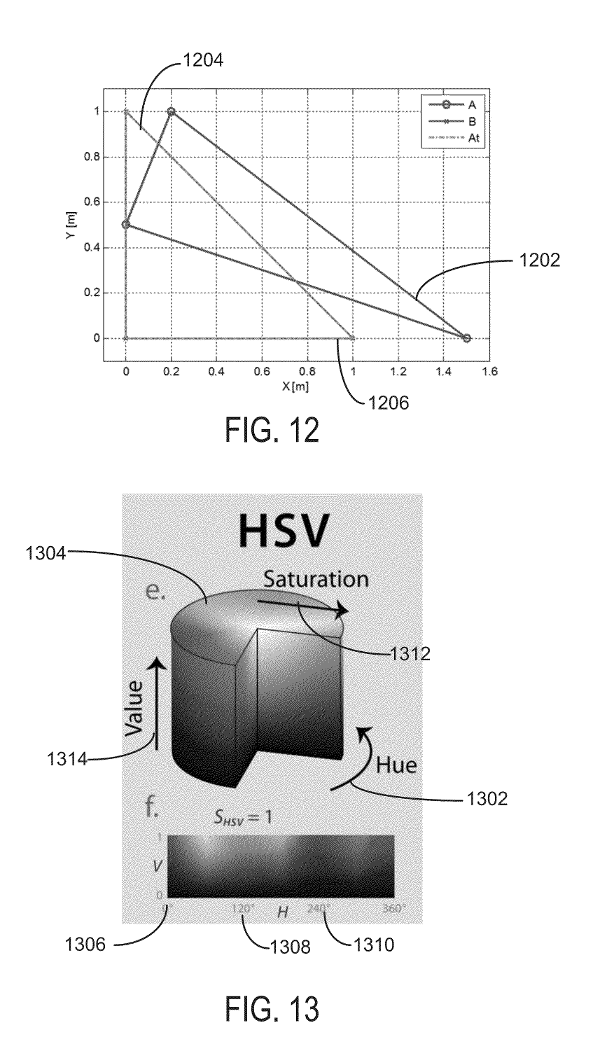

Applying the affine transformation to the second set of image data at process block 920 includes using the shoulder points 1108, 1110 and the head points 1106 for both sets of image data to find the matrix defining the affine transformation between the two sets of image data. The shoulder and head points (xᵢ, yᵢ), i=1, 2, 3 are used to define the following system of equations, as shown in equation (4):

$$\underbrace{( \begin{matrix}{x}_{1} & {y}_{1} & 1 \\ {x}_{2} & {y}_{2} & 1 \\ {x}_{3} & {y}_{3} & 1\end{matrix} )}_{A} {T}^{\overline{\_}} = \underbrace{( \begin{matrix}{x}_{1}^{′} & {y}_{1}^{′} & 1 \\ {x}_{2}^{′} & {y}_{2}^{′} & 1 \\ {x}_{3}^{′} & {y}_{3}^{′} & 1\end{matrix} )}_{B} \qquad ( 4 )$$

where A and B are defined using the points 1106, 1108, 1110 from the structured light emitter and the imaging device, respectively. Solving equation (4) above for T̅ allows calculating the affine transformation matrix to overlap both sets of points, using the transpose equation (5):

$${{T}^{\overline{\_}}}^{t} [ \begin{matrix}x \\ y \\ 1\end{matrix} ] = [ \begin{matrix}{x}^{′} \\ {y}^{′}\end{matrix} ] \qquad ( 5 )$$

where T̅^{t} is the 2×3 sub-matrix of the transpose of T̅. An example of this transformation for the case of two triangles is presented in FIG. 12, with the vertices of the first, irregular triangle 1202 representing the points from the structured light emitter, and the vertices of a second, regular triangle 1204 corresponding to the points acquired from the imaging device. Also shown in FIG. 12 is a resultant triangle 1206, from multiplying the triangle 1202 points from the structured light emitter by T̅^{t}, which overlaps perfectly with the second, regular triangle 1204.

Next, at process block 922, the first and second set of image data can be matched and combined. All points of the second set of image data obtained from the structured light emitter can be multiplied by the calculated transformation matrix T̅^{t} which rotates, scales, and translates the points into the Cartesian (i.e., horizontal, vertical) XBS image space. The second set of image data is then converted from a set of three-dimensional points to a matrix that contains the depth, or range, data in each (horizontal, vertical) matrix cell. Interior pixels that have missing data can be interpolated, and exterior pixels may be ignored. Then at process block 924, the resultant image, which combines the first and second set of image data with the depth data, is obtained.

In order to identify surface anomalies of the resultant image at process block 926, color may be used to present the two sets of image data in a logical way. In one non-limiting example, as shown in FIG. 13, hue, saturation and value, HSV, can be used as a cylindrical-coordinate representation of points in an RGB color model. The angle dimension 1302 of the cylinder 1304 represents hue, with pure red 1306 at 0°, green 1308 at 120°, and blue 1310 at 240°. The vertical axis of the cylinder represents saturation 1312 of the color which is how deep a color is. The radial distances represents value 1314, which is how light or dark a color is.

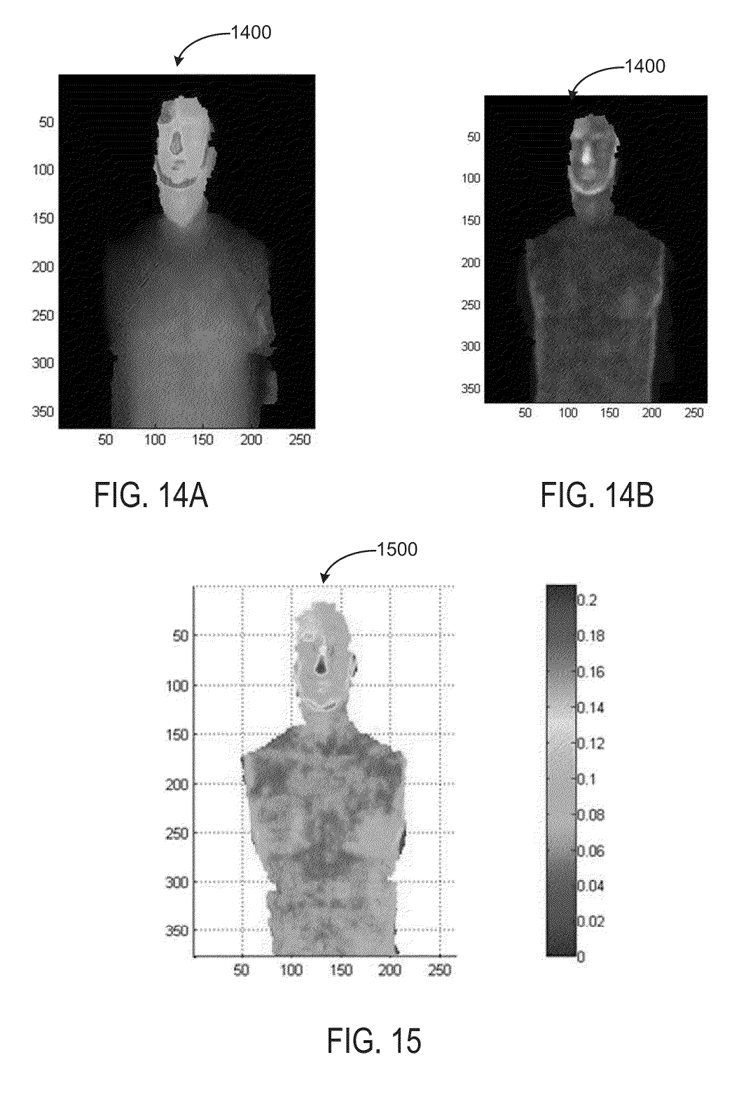

Thus, one way color may be used is to define the hue 1302 by the imaging device, such as the XBS, and the value 1314 by the structured light emitter depth data while keeping the saturation 1312 constant. This gives a resultant image 1400 as shown in FIG. 14A. The combination allows the different of materials to be processed by looking at colors, but focuses a viewer's attention by making the objects that are closer brighter. In another non-limiting example, as shown in FIG. 14B, hue 1302 may be defined by the structured light emitter depth data and the value 1314 by the imaging device, thus keeping the saturation 1312 constant in the resultant image 1400.

In yet another non-liming example, as shown in FIG. 15 another method of combining depth data and XBS image data is to create a three-dimensional structured light emitter-based mesh that is colored by the XBS image data. This method allows the viewer to interact with a three-dimensional representation 1500 with projected X-ray background material responses.

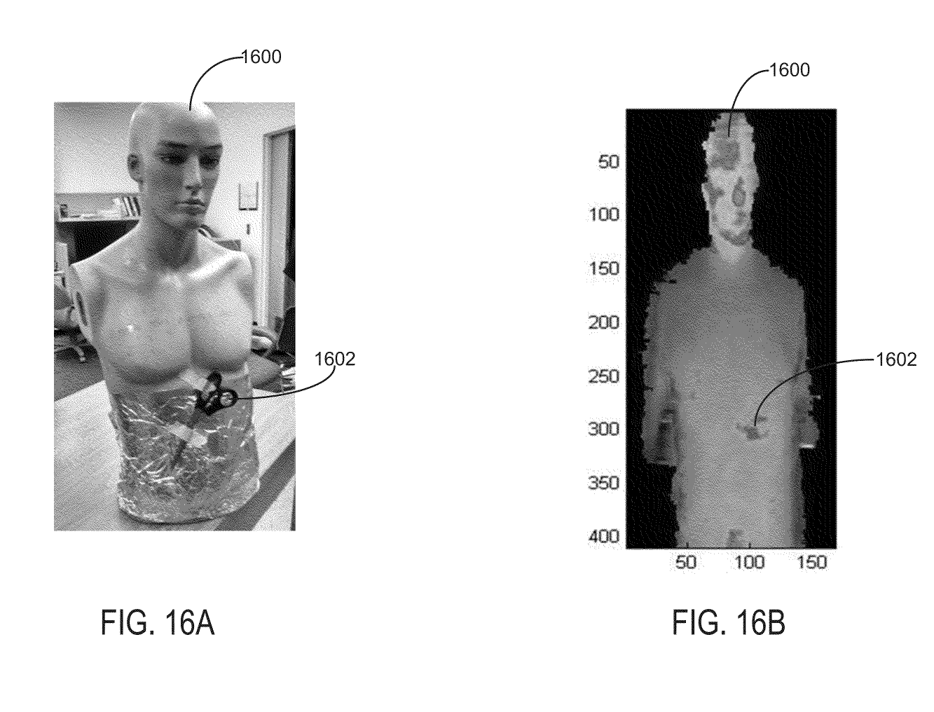

Turning now to FIG. 16A, an exemplary subject 1600 is shown having an object 1602 attached thereto. FIG. 16B shows the combined, resultant image of the subject 1600 shown in FIG. 16A. The object 1602 (e.g., a pair of scissors) appears as a darker color in FIG. 16B, but is brighter because of the added depth data acquired from the structured light emitter, which distinguishes from other dark colors. The imaging device (i.e., the XBS) allows one to see under clothing of the subject 1066, but with the added depth and image data obtained from the structured light emitter, the viewer is able to distinguish objects 1602 (i.e., threats) from bouncing X-Rays.

Thus, by adding a structured light emitter to an imaging device, such as a X-Ray Backscatter imager, surface anomalies created by objects can be easily and inexpensively obtained. In addition, the structured light emitter device does not increase scanning times and, therefore, subjects can be quickly and repeatedly scanned, if necessary. This can aid in the discrimination of threats by highlighting object bulges on a subject's skin. Depth data can be collected simultaneously with X-Ray Backscatter scanning, and the mapping of the X-Ray Backscatter onto the depth image is an automated process. Together these factors produce a system that is simple to implement and offers considerable improvement in identifying threats.

The present invention has been described in terms of one or more preferred embodiments, and it should be appreciated that many equivalents, alternatives, variations, and modifications, aside from those expressly stated, are possible and within the scope of the invention.

1. A system for determining a volume of an object of interest, the system comprising:
a structured light emitter configured to project a predetermined pattern of light onto the object of interest;
at least one sensor configured to acquire light after impinging the object of interest in the predetermined pattern to generate volumetric position data based thereon;
a processor configured to receive the volumetric position data and based thereon, generate a depth map of the object of interest and apply a geometric model to the depth map to calculate the volume of the object of interest; and
a display configured to indicate the volume of the object of interest based on a reconstructed volumetric shape determined by the geometric model.

2. The system as recited in claim 1 further comprising at least one positional control to position the object of interest at a predetermined distance from the structured light emitter and wherein the processor is further configured to generate the depth map using an assumption that the object of interest is positioned at the predetermined distance.

3. The system as recited in claim 1 wherein the processor is further configured to apply an edge detection algorithm to the depth map to isolate the object of interest.

4. The system as recited in claim 3 wherein the edge detection algorithm is a Sobel edge detector operator.

5. The system as recited in claim 1 wherein the depth data includes a plurality of distances corresponding to points along the object of interest, the plurality of distances measured from the structured light emitter to each of the points.

6. The system as recited in claim 1 wherein the geometric model is configured to divide the reconstructed volumetric shape into a plurality of slices and calculate the volume of the object of interest by summing a volume corresponding to each of the plurality of slices.

7. The system as recited in claim 1 wherein the at least one sensor includes a depth sensor.

8. The system as recited in claim 1 wherein the object of interest includes an arm of a subject and the processor is further configured to determine a condition of fluid retention within the arm.

9. A method for determining a volume of an object of interest, the method comprising:
projecting a predetermined pattern of light onto the object of interest from a structured light emitter;
acquiring depth data corresponding to the object of interest provided at a predetermined location from the structured light emitter in the predetermined pattern of light;
generating a depth map of the object of interest from the depth data;
applying an edge detection algorithm to the depth map to isolate the object of interest;
reconstructing the depth map using a geometric model representative of a volumetric shape of the isolated object of interest; and
calculating the volume of the object of interest based on the reconstructed volumetric shape.

10. The method as recited in claim 9 wherein applying the edge detection algorithm includes performing a Sobel edge detector operator to the depth data.

11. The method as recited in claim 10 wherein receiving the depth data includes acquiring a plurality of distances corresponding to points along the object of interest, the plurality of distances measured from the structured light emitter to each of the points.

12. The method as recited in claim 9 wherein reconstructing the depth map using the geometric model includes dividing the reconstructed volumetric shape into a plurality of slices and calculating the volume of the object of interest by summing a volume corresponding to each of the plurality of slices.

13. The method as recited in claim 9 wherein receiving the depth data corresponding to the object of interest includes acquiring the depth data from a depth sensor.

14. The method as recited in claim 9 wherein calculating the volume of the object of interest includes calculating a volume of an arm of a subject to determine a condition of fluid retention within the arm.

15. A system for identifying surface anomalies of an object of interest, the system comprising:
an imaging device configured to acquire a first set of image data corresponding to the object of interest;
a structured light emitter configured to project a predetermined pattern of light onto the object of interest;
at least one sensor configured to acquire light after impinging the object of interest in the predetermined pattern to generate depth data and a second set of image data based thereon;
a processor configured to receive the first set of image data, the second set of image data and the depth data and based thereon, generate a depth map of the object of interest and identify common points between the first set of image data and the second set of image data; and
a display configured to indicate surface anomalies of the object of interest based on a resultant image created from correlating the common points between the first set of image data and the second set of image data, the resultant image including the depth data.

16. The system as recited in claim 15 wherein the processor is further configured to apply an edge detection algorithm to the first set of image data and the second set of image data to identify a boundary of the object of interest.

17. The system as recited in claim 15 wherein the common points identified between the first set of image data and the second set of image data are scaled using a scaling algorithm, the scaling algorithm allowing the first set of image data to be combined with the second set of image data in a common format.

18. The system as recited in claim 17 wherein the scaling algorithm is an affine transformation applied to the second set of image data to at least one of scale, sheer, rotate, and translate sets of points corresponding to the second set of image data.

19. The system as recited in claim 15 wherein the object of interest is a subject.

20. The system as recited in claim 19 wherein the common points between the first set of image data and the second set of image data include at least one of a head point and a shoulder point of the subject.

21. A method for identifying surface anomalies of an object of interest, the method comprising:
projecting a predetermined pattern of light onto the object of interest from a structured light emitter;
receiving a first set of image data from an imaging device corresponding to an object of interest;
acquiring depth data and a second set of image data, simultaneously, corresponding to the object of interest provided at a predetermined location from the structured light emitter in the predetermined pattern of light;
generating a depth map of the object of interest from the depth data;
applying an edge detection algorithm to the first set of image data and the second set of image data to identity a boundary of the object of interest;
identifying common points between the first set of image data and the second set of image data;
combining the first set of image data with the second set of image data based on the common points to obtain a resultant image including the depth data of the object of interest; and
identifying surface anomalies of the object of interest from the resultant image.

22. The method as recited in claim 21 further comprising the step of applying a scaling algorithm to the first set of image data and the second set of image data, the scaling algorithm allowing the first set of image data to be combined with the second set of image data in a common format.

23. The method as recited in claim 22 wherein applying the scaling algorithm includes applying an affine transformation to the second set of image data to at least one of scale, sheer, rotate, and translate sets of points corresponding to the second set of image data.

24. The method as recited in claim 21 wherein identifying common points between the first set of image data and the second set of image data includes identifying at least one of a head point and a shoulder point of the object of interest.

25. A system comprising:
an imaging device configured to acquire a first set of image data corresponding to an object of interest;
a structured light emitter configured to project a predetermined pattern of light onto the object of interest;
at least one sensor configured to acquire light after impinging the object of interest in the predetermined pattern to generate depth data and a second set of image data based thereon;
a processor configured to receive at least one of the first set of image data, the second set of image data, and the depth data and based thereon, generate a resultant image including the depth data; and
a display configured to display the resultant image.

26. The system as recited in claim 25 wherein the processor is further configured to apply a geometric model to the resultant image to calculate a volume of the object of interest.

27. The system as recited in claim 26 wherein the display is configured to further indicate the volume of the object of interest depicted in the resultant image based on a reconstructed volumetric shape determined by the geometric model.

28. The system as recited in claim 27 wherein the geometric model is configured to divide the reconstructed volumetric shape into a plurality of slices and calculate the volume of the object of interest by summing a volume corresponding to each of the plurality of slices.
